(19) United States
(12) Patent Application Publication
(10) Pub. No.: US 2012/0136968 A1
(43) Pub. Date: May 31, 2012

(54) SUBSCRIPTION-BASED DIGITAL CONTENT MANAGEMENT AND DELIVERY SYSTEM AND METHOD

(76) Inventors: Christopher R. Wojcik, Lake Quivira, KS (US); Ronald A. Honeyman, Lenexa, KS (US)

(21) Appl. No.: 12/957,137

(22) Filed: Nov. 30, 2010

(51) Int. Cl. G06F 15/16

(52) U.S. Cl. 709/219

(57) ABSTRACT

A subscription-based digital content management and delivery system for managing and delivering digital content including and application layer with presentation, service, model and persistence sub layers. A task management functional model is provided for receiving data from clients, creating an issue with client-supplied digital content and publishing the issue to users. Business rules are programmed in a back end of the system. A flexible task processing system communicates processing requests between clients and servers and maximizes interaction with users.

### CROSS-REFERENCE TO RELATED APPLICATION

This application claims priority in U.S. Provisional Patent Application No. 61/256,276, filed Nov. 30, 2009, which is incorporated herein by reference.

### BACKGROUND OF THE INVENTION

1. Technical Field

The present disclosed technology relates generally to digital content management and delivery, and in particular a system that manages creation of the digital content by clients with tasks, and that permits access to the digital content by users with a subscription.

2. Background

Various systems have previously been utilized for creating, managing and delivering digital content. Various media and distribution trade channels have also been utilized. Heretofore there has not been available a digital content management and delivery system with the advantages and features of the disclosed subject matter.

### SUMMARY OF THE INVENTION

In the practice of the present invention, a subscription-based digital content management and delivery system is provided including application, presentation, service, model and persistence layers. A task management functional module is provided. Complexities associated with business rules are housed in a back end of the system. A flexible task processing system communicates processing requests between clients and servers and maximizes interaction with users.

### BRIEF DESCRIPTION OF THE DRAWINGS

The drawings constitute a part of this specification and include exemplary embodiments of the disclosed subject matter illustrating various objects and features thereof, wherein like references are generally numbered alike in the several views.

FIG. 1 is a high-level diagram of a subscription-based digital content management and delivery system embodying an aspect of the present invention.

FIG. 2 is a system overview of the subscription-based system.

FIG. 3 is a functional block diagram of the application server of the subscription-based system.

FIG. 4 is a functional block diagram of the service layer of the subscription-based system.

FIG. 5 is a functional block diagram for the task management of the subscription-based system.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Subscription-Based Digital Content Management and Delivery System 102

It is to be understood that the invention can be embodied in various forms and is not to be limited to the examples discussed above. As will be appreciated by one of ordinary skill in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer-readable storage medium having computer-readable program code means embodied in the storage medium. Any suitable computer readable storage medium may be utilized, including hard disks, CD-ROMs, optical storage devices, or magnetic storage devices.

The present invention is described below with reference to block diagrams and flowchart illustrations of methods, apparatus (i.e. systems) and computer program products according to an embodiment of the disclosed subject matter. It will be understood that each block of the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instructions for performing the specified functions. It will also be understood that each block of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

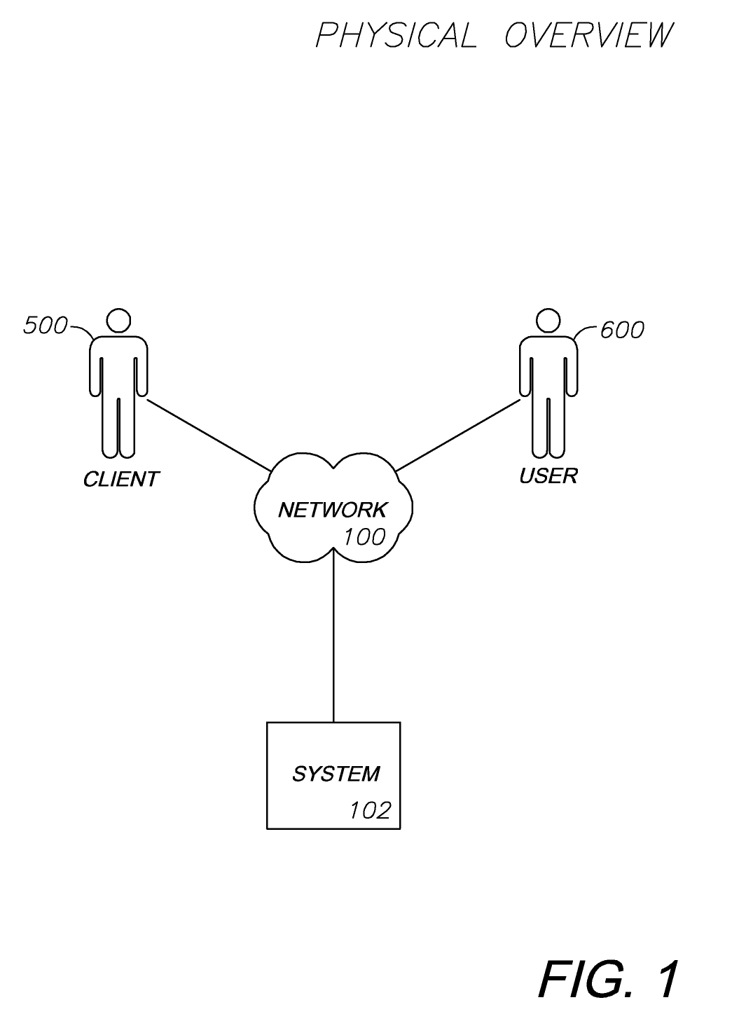

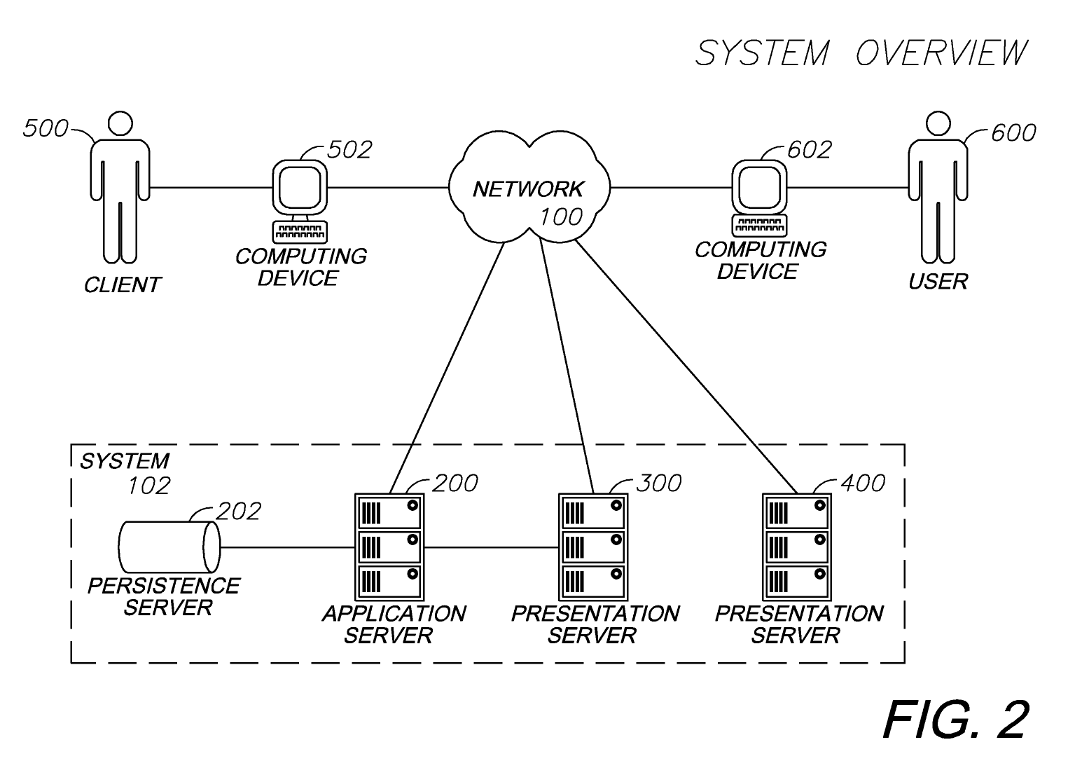

FIGS. 1-2 show components of a subscription-based digital content management and delivery system in accordance with the disclosed subject matter. A client 500 creating digital content for users 600 transmits data pertaining to digital content to the system 102 through a network 100. The system 102 receives the data from the client 500, and a task management system 232 operating on an application server 200 processes the data and generates an appropriate task, which can take the form of an e-mail notification, a text message, a tutorial window in an application running on the application server 200, or any other suitable form. The task is sent to the client 500 in order to guide the client in completing processing or completing creation of the digital content. Once the digital content is created, it is presented to users 600 by publishing an issue. An issue is the collection of images, songs, videos and text to be delivered to the user 600. A user is a person who is the recipient of an issue. Users are defined by their username, email address, and password. A user 600 having a subscription for the digital content created by the client 500 is permitted access to the issue. In this exemplary embodiment, a client 500 and a user 600 are represented, however, the system 102 can be connected to more than one client 500 or user 600. Client 500 and user 600 interface with the system 102 using computing devices 502, 602. The computing device 502, 602 may consist of a variety of devices including, but not limited to an embedded computer, mainframe computer, minicomputer, personal computer, handheld computer, personal digital assistant, or smartphone. Each user can have multiple devices.

The system 102 is illustrated in FIG. 2 as a software program executing on an application server 200. The system 102 comprises an application server 200, a persistence server 202, and presentation servers 300, 400 connected over a network 100. The servers 200, 202, 300, 400 and computing devices 502, 602 consist of one or more microprocessors connected to memory and a telecommunications device that are capable of accessing the network 100 over a communications link. The network 100 may consist of a multitude of individual or networked computing devices that are interconnected and exchange data, such as local area networks (LANs), wide area networks (WANs), dedicated communications lines, or through the worldwide web (Internet). The data may be encoded in hypertext markup language (HTML) for exchange over the network in hypertext transfer protocol (HTTP). The system 102 is designed around a standard multi-tier architecture including, but not limited to: a presentation layer 220 deployed on each of the presentation servers 300, 400; an application layer 210 deployed on the application server 200; and a persistence layer 260 deployed on the persistence server 202. The presentation layer 220 and persistence layer 260, as well as a service layer 230 and model layer 250 reside within the application layer 210 to maintain a separation of responsibility within the application layer 210. Each will now be discussed in turn.

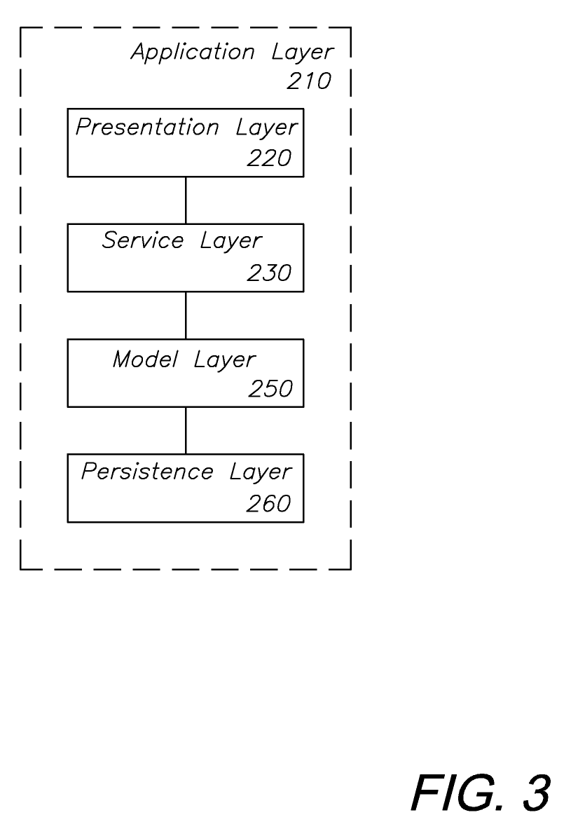

FIG. 3 is a functional block diagram illustrating the logical connections between the subset of layers within the application layer 210. The application layer 210 is responsible for the protocols and methods for processing communication of the system 102 using the network 100. The application layer 210 deployed on the application server 200, preferably an Apache Tomcat server running Java, provides the Servlet engine that will serve the dynamic data requests of clients 500 and users 600. The persistence layer 260 handles the mapping of objects to database tables in MySQL. The presentation layer 220 is responsible for receiving task requests from the client 500 or user 600, interfacing with the service layer 230, and translating the task request results to the requestor. The presentation layer 220 takes the HTTP request from the client 500 in addition to any parameters or XML and assembles business entity objects. These objects are then passed to the service layer 230 as parameters to the business methods. The resulting objects are returned and translated into XML for return to the client 500. Struts version 2.0 is used as the web framework. A user 600 performs the requests via the web interface with the service layer 230 using the appropriate parameters. After execution, the user 600 is sent to the appropriate web page.

The presentation layer 220 that is deployed on the presentation server 300, e.g. an Apache server, provides HTTP service for dynamic data that has been customized by the client 500 when creating issues for the user 600 including translating the various business entity objects into various presentation representations, and implementation of the RESTful web services. The RESTful web services are used to exchange data between the client 500 and the application server 200. The presentation layer 220 that is deployed on the presentation server 400, preferably an Akami server, provides the basic HTTP and HTTPS service, and is responsible for providing content and application delivery including, but not limited to simple HTML pages, and other static content such as images, JavaScript, media files, style sheets, etc. The service layer 230 is responsible for the execution of the business rules. The model layer is responsible for representing business entity objects.

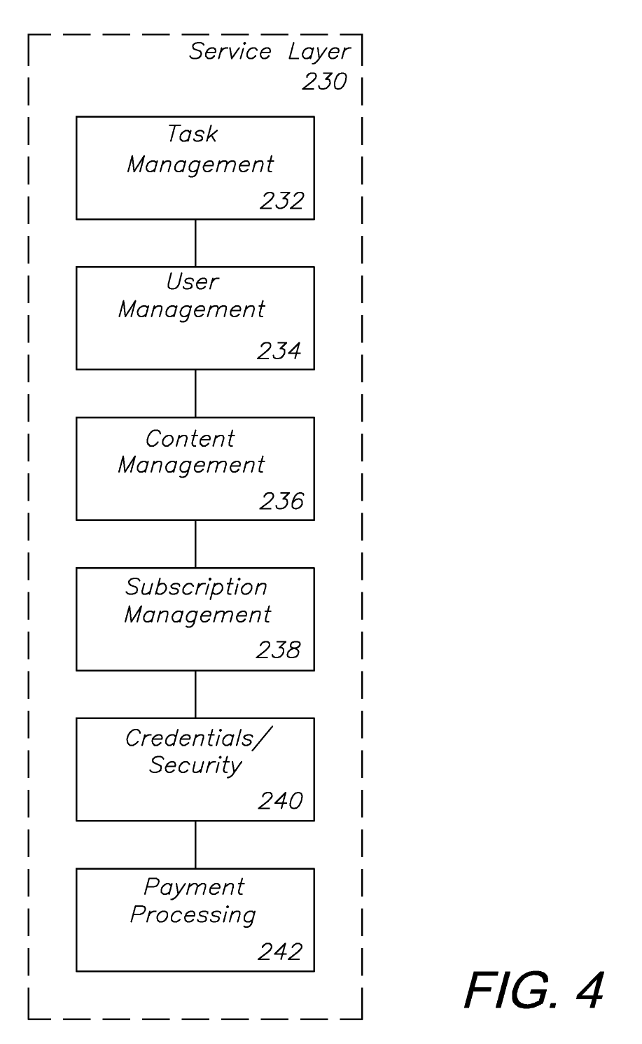

FIG. 4 is a functional block diagram illustrating the logical connections between the subset of layers within the service layer 230. The service layer 230 subset layers or components include, but are not limited to: task management 232; user management 234; content management 236; subscription management 238; credentials/security; and payment processing 242. The task management 232 component allows the application server 200 to tell the client 500 what task needs to be executed in order to complete an issue. The task management 232 component monitors the other service layer 230 components and creates an appropriate task to be sent to the client 500 when changes occur. The task management 232 component also monitors the other service layer 230 components and retrieves the appropriate task for a user 600.

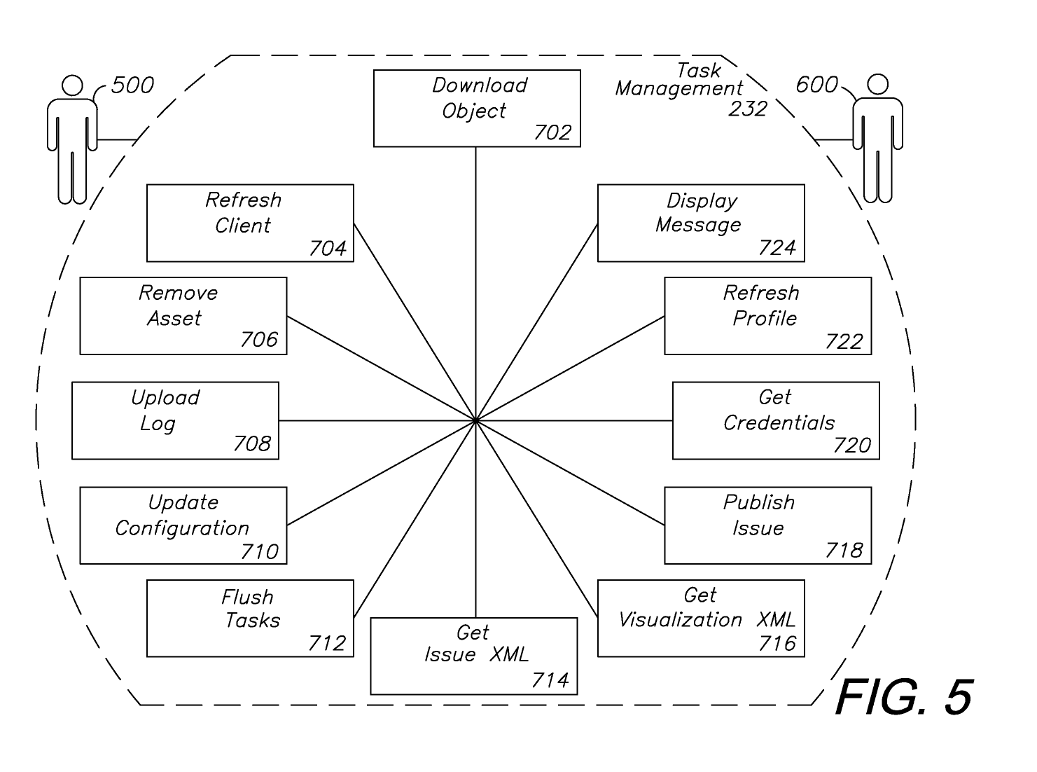

FIG. 5 is a functional block diagram illustrating the tasks the task management 232 system can send to either a client 500 or user 600.

The following is a non-exclusive list of tasks the task management 232 system can send to a client 500. A download object task 702 is sent to a client 500 containing a URL to the object to notify them that there is an object that needs to be downloaded to the issue. A refresh client task 704 prompts the client 500 to contact the task management 232 system to get more tasks. A remove asset task 706 prompts the client to remove a physical asset including, but not limited to an unlicensed image. An upload log task 708 is sent to a client 500 to request the client 500 to send log files to the application server 200 for investigation. An update configuration task 710 prompts the client 500 to update one or more present configuration values. A flush tasks task 712 operates as a reset tool and prompts a client 500 to delete all outstanding tasks in order to get a new list of tasks. A get issue XML task 714 prompts the client 500 to get the XML that represents an issue. A get visualization XML task 716 prompts the client 500 to get the XML that represents a specific visualization. A publish issue task 718 prompts the client 500 to display a new issue to the user 600. A get credentials task 720 prompts the client 500 to get a new set of system credentials. A refresh profile task 722 is sent to the client 500 when a user's 600 profile or subscription has been updated on the application server 200.

The following is a non-exclusive list of tasks the task management 232 system can send to a user 600. A display message task 724 sends a message to a specified user 600, a specified computing device 602, all users 600 within a subscription, or all users 600.

The user management 234 component is responsible for creation, updating, and retrieving information on a user 600. The user management 234 component has business rules related to users 600 such as uniqueness of the username, uniqueness of the user 600 email address, and validation of the user 600 email prior to logging into the system 102. The user management 234 component also supports friends and passing subscriptions, and importing friends from external sources such as Facebook websites.

The content management 236 component is responsible for the business rules related to an issue and its supporting objects. An issue has containers that represent the various sections presented on the computing devices 502, 602 display, such as headline, major story, or feedback. Each container contains multiple media items such as images, songs, and videos that are displayed. The issue also has preview images that are used to display the previews of a specific issue. The content management 236 component has two primary business functions. First, it has the logic that is used by the curator or client to publish an issue. Publishing an issue on the application server 200 is the last step when the curator is building an issue.

The task management system 232 monitors the content management 236 system for an indication that a particular issue is ready to be delivered to a client 500. When an issue is ready for publication, the application server 200 validates all of the media items that exist as part of the issue. Once the validation is complete, the application server 200 creates an XML document representing the issue and initiates the task management 232 component to create the appropriate tasks. The other primary function of the content management 236 component is to return the XML to clients 500 as they request it. This XML document is cached in the database on the persistence server 202 for maximum performance, however a validation is performed on the issue to ensure that a user 600 owns the issue prior to returning the XML. Validating ownership of the issue prevents the XML from being cached and delivered as static content.

The subscription management 238 component manages the subscription rights of users 600. Each subscription can have multiple offerings. Each offering defines how a subscription can be purchased by a user 600. By way of example, and not to be construed as limiting, a subscription offer may be limited by duration (e.g., three months, six months, specific start and end date, etc.), limited by cost (e.g., a paid trial or free trial, cost amount, etc.), or by type of subscription plan (e.g., base plan, deluxe plan, etc.). Each subscription offering may have one or more payment options. Each subscription offer may also include free issues when a user 600 activates a subscription. By way of example, and not to be construed as limiting, a free issue may be offered as a back issue, or a specific issue. A back issue may be one or more preceding issues based on the most recently published issue. A specific issue is a particular issue received by all users 600 when they activate a subscription.

Subscription processing is provided whereby jobs related to subscription processing are executed to facilitate operation of the system 102. Such processing includes but is not limited to notifying users 600 of an upcoming subscription end date, inactivating subscriptions that are no longer valid, activating pending user 600 subscriptions upon renewal, and a payment sweeper enabling the system 102 to sweep through payments from users 600 that the system 102 did not receive a confirmation on and validate the status.

The credentials and security 240 component manages the access rights of clients 500, users 600, and the system 102. User 600 credentials are used to authenticate a user 600 and their subscription information, and include username and password. A time credential prevents a user 600 from being able to set the time on his or her computing device 602 ahead in order to receive future issues before their delivery dates. A directory credential controls all interaction between the client 500 and the system 102. The credential requires an encrypted token that requires its value to be coordinated between the client 500 and the presentation server 400. The system 102 is capable of encrypting all videos, songs, or images before they are downloaded to a client 500. An issue credential is provided for each client 500 and is used to decrypt the video, song, or image permitting it to be displayed and published with a particular issue.

The payment processing 242 component enables the system 102 to process user 600 subscription payments. The payment processing 242 system interfaces with current payment systems, including, but not limited to, the Amazon flexible payment system, or a one-time use self-validating pin associated with a user in the database on the persistence server 202.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A subscription-based digital content management and delivery system for managing and delivering digital content from a client to a user over a network, which system comprises:
an application server connected to the network;
a presentation server connected to the application server and the network;
said application server including a task management system programmed to receive data from a client, generate an appropriate task and send the task to the client; and
the presentation server being programmed to publish an issue comprising the digital content to multiple users over the network.

2. The system according to claim 1, which includes:
a client computing device connected to the network; and
a user computing device connected to the network.

3. The system according to claim 2, which includes:
said computing devices being one or more from among the group comprising: embedded computer; mainframe computer; mini computer; personal computer; handheld computer; personal digital assistant; and smart phone.

4. The system according to claim 2, which includes:
said issue being one or more from among the group comprising: images; music; video; and text.

5. The system according to claim 2, which includes:
said network being one or more from among the group comprising: networked computing devices; local area networks (LANs); wide area networks (WANs); dedicated communications lines; and the worldwide web (Internet).

6. The system according to claim 2, which includes:
a persistence server connected to the application server; and
said persistence server being programmed to contain a database comprising cached documents created by clients.

7. The system according to claim 6, which includes:
said task management system including an ownership validation function adapted for performing ownership validation on an issue as a condition of delivering it to a client.

8. The system according to claim 2, which includes:
a presentation server connected to the network and the application server; and
said presentation server being programmed with a presentation layer residing within an application layer.

9. The system according to claim 2, which includes:
said presentation layer being adapted for receiving task requests, parameters and XML from a client or a user and assembling business entity projects.

10. The system according to claim 2, which includes:
a presentation layer receiving HTTP requests from a client.

11. The system according to claim 2, which includes:
an application layer including a presentation sublayer, a service sublayer, a model sublayer and a persistence sublayer.

12. A method of managing and delivering digital content, which comprises the steps of:
providing a server system including an application server and a presentation server;
connecting the server system to a network;
providing a task management system on the server system;
receiving with said task management system data from a client;
generating an appropriate task from said client data;
sending said task to the client; and
publishing with the presentation server an issue comprising the digital content to a user over the network.

13. The method according to claim 12, which includes the additional steps of:
connecting a client computing device to the server system over the network; and
connecting a user computing device to the server system over the network.

14. The method according to claim 13, which includes the additional steps of:
providing said server system with a persistence server;
programming said persistence server to contain a database; and
storing in said persistence server database cached documents created by clients.

15. The method according to claim 13, which includes the additional step of:
programming said server system with an application layer.

16. The method according to claim 15, which includes the additional step of:
providing said application layer with a presentation sublayer, a service sublayer, a model sublayer and a persistence sublayer.

17. The method according to claim 16, which includes the additional step of:
inputting HTTP requests from clients on said presentation layer.

18. A method of managing and delivering digital content, which comprises the steps of:
providing a server system including a persistence server, an application server and a presentation server;
connecting the persistence and presentation servers to the application server;
connecting the application and presentation servers to a network;
providing and operating a task management system on the application server;
receiving with said task management system data comprising digital content from a client;
generating with said task management system an appropriate task from said client data;
sending said task to the client;
using said task to guide said client recipient in completing processing and/or creation of the digital content;
defining users with one or more of usernames, e-mail addresses and passwords;
creating user subscriptions authorizing user access to said digital content; and
publishing with the presentation server an issue comprising the digital content to a user with subscriptions over the network.

19. The method according to claim 18, which includes the additional steps of:
validating client ownership of an issue; and
delivering said issue to a client with validated ownership.

20. The method according to claim 18, which includes the additional steps of:
providing an additional presentation server; and
connecting said additional presentation server to the network.
